(19) United States
(12) Patent Application Publication
(10) Pub. No.: US 2014/0326097 A1
(43) Pub. Date: Nov. 6, 2014

(54) ROBOT

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: CHIA-PENG DAY, Santa Clara, CA (US); XIAO-MING XU, Shenzhen (CN); HUA HUANG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/270,444

(22) Filed: May 6, 2014

(30) Foreign Application Priority Data
May 6, 2013 (CN) 2013101619902

(51) Int. Cl. B25J 18/00

(52) U.S. Cl. CPC B25J 18/00; Y10S 901/25
USPC 74/490.01; 901/25

(57) ABSTRACT

Compact robot with a reduced operational envelope includes a support frame, two robot arm assemblies, and two actuating mechanisms. The support frame includes a top plate and a bottom plate. Each robot arm assembly includes a first arm, a second arm intersecting with the first, and a third arm intersecting with the second. The first arm drives the second arm to move along the first arm, the second arm drives the third arm to move along the second arm. The actuating mechanisms are coupled to the two third arms. Each third arm drives an actuating mechanisms to move along the third arm. A moving direction of each actuating mechanism as driven by the third arm is inclined relative to the driving directions of the first arm and the second arm.

### CROSS-REFERENCE TO RELATED APPLICATIONS

This application is related to three co-pending U.S. patent applications (Attorney Docket Nos. US51918, US51920, US51921), entitled “DRIVING MECHANISM”, “DRIVING MECHANISM”, “THREE-AXES ROBOT”, respectively, by Day et al. The applications have the same assignee as the instant application and are concurrently filed on the same day. The disclosure of the above-identified applications is incorporated herein by reference.

### FIELD

The present disclosure relates to robots, and particularly to a small sized robot.

### BACKGROUND

A robot can be applied to industrial processes, and particularly applied to heavy processes, repetitive processes, or special process environments, for example. A robot can be used in assembling of an electronic device, such as mobile phone, for example. However, electronic devices, for example a smart phone, tablet computer, are gradually becoming thinner, thus the assembling, machining, or handling of the electronic devices becomes harder and requires greater precision. A robot can include multiple arms, and each arm can include a plurality of gears or reducers for transmitting movements. However, the robot can produce substantial vibrations. The gears and the reducers are very heavy, such that inertia of the robot is large in operation. Additionally, elements of the electronic devices are very small and the fitting space associated therewith is small. Thus, the robot can be restricted to electronic devices.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a first embodiment of a robot.

FIG. 2 is an exploded, isometric view of the robot of FIG. 1.

FIG. 3 is an isometric view of a second embodiment of a robot.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The term “coupled” is defined as being connected, whether directly or indirectly through intervening components, and is not necessarily limited to physical connections. The connection can be such that objects are permanently connected or releasably connected.

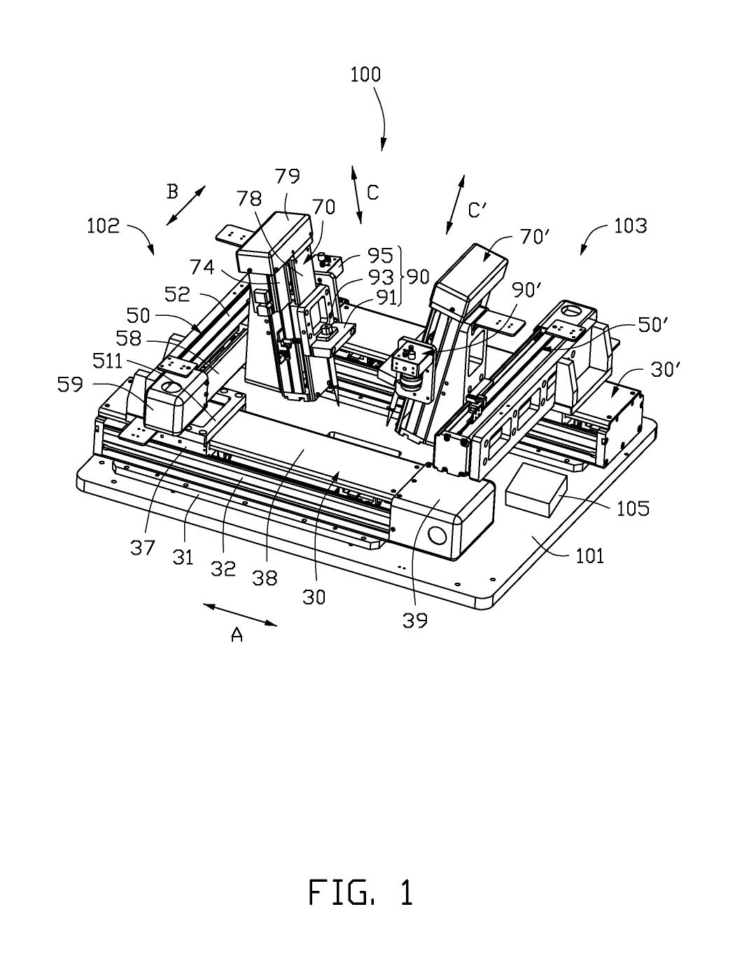

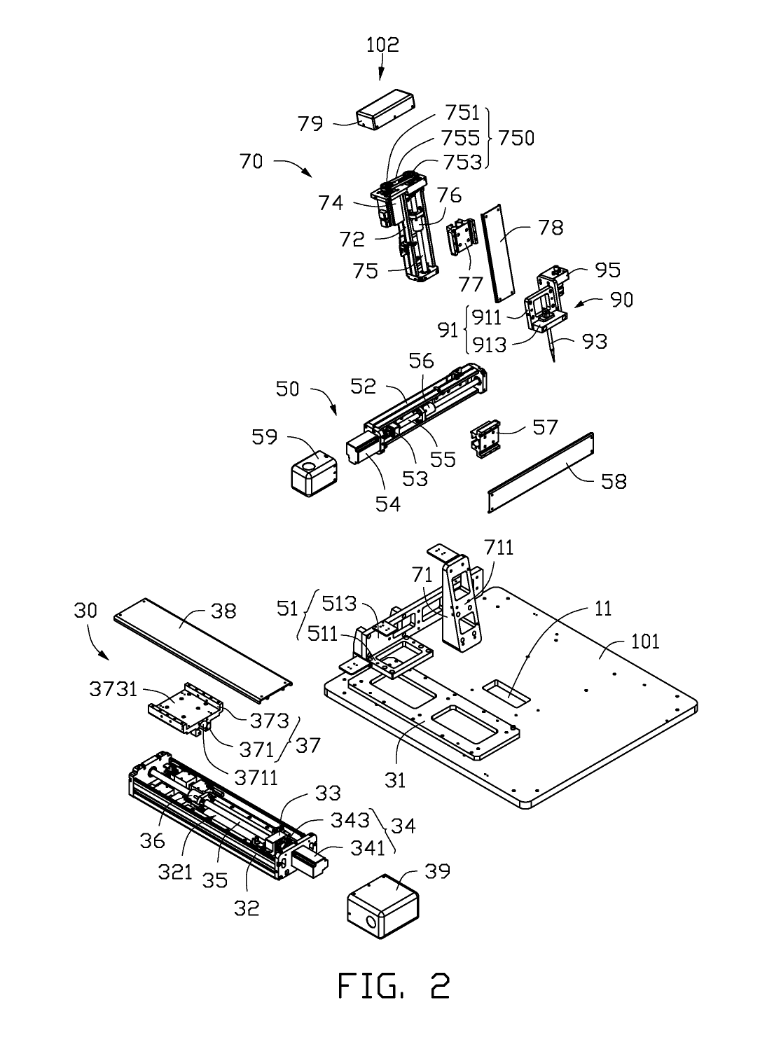

FIGS. 1 and 2 illustrate a first embodiment of a robot 100. The robot arm 100 can include a support member 101, a first robot arm assembly 102, a second robot arm assembly 103, a first actuating mechanism 90, a second actuating mechanism 90′, and at least one controller 105 (schematically shown in FIG. 1). The first robot arm assembly 102, the second robot arm assembly 103, and the at least one controller 105 can be mounted on the support member 101. The first robot arm assembly 102 and the second robot arm assembly 103 can be electrically coupled to the at least one controller 105. The first actuating mechanism 90 can be coupled to the first robot arm assembly 102, and the second actuating mechanism 90′ can be mounted to the second robot arm assembly 103. The first actuating mechanism 90 and the second actuating mechanism 90′ can be controlled by the at least one controller 105, to do some tasks, such as detect and pick up, assemble, or machine, a workpiece. In the illustrated embodiment, the first actuating mechanism 90 and the second actuating mechanism 90′ are configured for detecting a workpiece (not shown). The support member 101 is substantially a rectangular plate, and configured to be assembled on a worktable when in use. The support member 101 can support the first robot arm assembly 102 and the second robot arm assembly 103. The support member 101 can define a position hole 11 for positioning the workpiece. In an alternative embodiment, the workpiece can be not positioned on the support member 101, such as being positioned on a worktable (not shown) for example.

The first robot arm assembly 102 and the second robot arm assembly 103 are in the same structure, thus only the first robot arm assembly 102 is explained in detail. The first robot arm assembly 102 can include a first arm 30, a second arm 50, and a third arm 70. The first arm 30 can be mounted on the support member 101. The second arm 50 can be mounted on the first arm 30. The third arm 70 is mounted on the second arm 50. The first arm 30 can drive the second arm 50 to move along a first direction A. The second arm 50 can drive the third arm 70 to move along a second direction B. A driving direction of the third robot arm 70 is along a third direction C. The first direction A and the third direction C can be perpendicular to the second direction B. The third direction C is not required to be perpendicular to the first direction A. The first actuating mechanism 90 can be mounted on the third arm 70 and driven by the third arm 70. A moving direction of the first actuating mechanism 90, which is driven by the third arm 70, can be inclined relative to a plane of the third arm 70 moving therein. Because the third arm 70 can move along the first direction A and the second direction B, the moving direction of the first actuating mechanism 90 driven by the third arm 70 can be inclined relative to a plane parallel to the first direction A and the second direction B.

FIG. 2 illustrates that the first arm 30 can include a connecting member 31, a mounting member 32, a connection reinforcing member 33, a driving member 34, a first transmission member 35, a second transmission member 36, a third transmission member 37, a protecting plate 38, or a protecting cover 39. The connecting member 31 can be substantially a rectangular plate. The connecting member 31 can be mounted on the support member 101 along the first direction A and located adjacent to an edge of the support member 101. The mounting member 32 can be substantially a frame and can define an opening 321 for mounting the connection reinforcing member 33, the driving member 34, the first transmission member 35, the second transmission member 36, the third transmission member 37, and the protecting plate 38. The mounting member 32 can be coupled to the connecting member 31 by fasteners for example. A longitudinal direction of the mounting member 32 can be parallel to the first direction A.

The connection reinforcing member 33 can be fixed to a distal end of the mounting member 32 and received in the opening 321. The driving member 34 can include a driving body 341 and a driving end 343 protruding from the driving body 341. The driving body 341 can be mounted on an end wall of the mounting member adjacent to the connection reinforcing member 33. The driving end 343 can be inserted through the end wall of the mounting member 32 and driving end 343 extends to the connection reinforcing member 33, thus the driving end 343 can be received in the mounting member 32. The first transmission member 35 can be substantially a rod and positioned in the mounting member 32 along the first direction A. A first end portion of the first transmission member 35 can be rotatably coupled to a wall of the mounting member 32 away from the connection reinforcing member 33, and a second end portion of the first transmission member 35 can be inserted through the connection reinforcing member 33 and coupled to the driving end 343 of the driving member 34. The connection reinforcing member 33 can be rotatably sleeved on a connecting portion of the first transmission member 35 and the driving end 343 to strengthen a connection of the first transmission member 35 and the driving end 343. The driving body 341 can drive the driving end 343 to rotate. Thus, the driving end 343 rotates the first transmission member 35. In the illustrated embodiment, the driving member 34 is a motor. The first transmission member 35 is a guide screw lead.

The second transmission member 36 can be substantially cylindrical, and rotatably sleeved on the first transmission member 35 and threaded with the first transmission member 35. The third transmission member 37 can include a first fixing portion 371 and a second fixing portion 373 located upon the first fixing portion 371. The first fixing portion 371 can be substantially cylindrical and define a through hole 3711 along a center axis thereof. The through hole 3711 can match with the second transmission member 36, and the first fixing portion 371 can be fixedly sleeved on the second transmission member 36 via the through hole 3711. The second fixing portion 373 can be substantially cuboid. Opposite sides of the second fixing portion 373 can be supported on sides of the mounting member 32 along the first direction A, such that the mounting member 32 can guide the second fixing portion 373 in operation. The second fixing portion 373 can define a receiving groove 3731 at a top surface. The protecting plate 38 can be a plate matching with the mounting member 32 and fixed on the mounting member 32. The protecting plate 38 can be partly received in the receiving groove 3731 to cover the opening 321 and to prevent dust or grease from entering into the mounting member 32. The protecting cover 39 covers the driving body 341 of the driving member 34, thereby preventing dust or grease from entering into the driving body 341.

A structure of the second arm 30 can be similar to the first arm 30, thus an explanation of the second arm 50 is not required. The second arm 30 can include a connecting member 51, a mounting member 52, a connection reinforcing member 53, a driving member 54, a first transmission member 55, a second transmission member 56, a third transmission member 57, a protecting plate 58, and a protecting cover 59. The connecting member 51 can be a frame and include a first connecting portion 511 and a second connecting portion 513 fixedly coupled to the first connecting portion 511. The first connecting portion 511 can be a substantially rectangular frame and parallel to the support member 101. The first connecting portion 511 can be fixedly coupled to the second fixing portion 373 of the third transmission member 37. Thus, the connecting member 51 can move along the first direction A with the third transmission member 37. The second connecting portion 513 can be perpendicular to the first connecting portion 511, and a first end of the second connecting portion 513 can be coupled to the first connecting portion 511. A longitudinal direction of the second connecting portion 513 can be parallel to the second direction B. The respective structures or coupling relationships of the mounting member 52, the connection reinforcing member 53, the driving member 54, the first transmission member 55, the second transmission member 56, the third transmission member 57, the protecting plate 58, and the protecting cover 59 are same as those of the mounting member 32, the connection reinforcing member 33, the driving member 34, the first transmission member 35, the second transmission member 36, the third transmission member 37, the protecting plate 38, and the protecting cover 39. Thus, explanations are omitted. The first transmission member 55 of the second arm 50 can be positioned along the second direction B.

A structure of the third arm 30 can be similar to the first arm 30 and the second arm 50. Thus, an explanation of the third arm 70 is simplified. The third arm 70 can include a connecting member 71, a mounting member 72, a driving member 74, a first transmission member 75, an intermediate transmission assembly 750, a second transmission member 76, a third transmission member 77, a protecting plate 78, and a protecting cover 79. The connecting member 71 can be a substantially triangular prism and mounted on the third transmission member 57 of the second arm 50, perpendicular to the support member 101. The connecting member 71 can include an inclined surface 711. The inclined surface 711 can be located at a side of the connecting member 71 away from the third transmission member 57. The inclined surface 711 can be inclined relative to the support member 101. A distance between the inclined surface 711 and the third transmission member 57 of the second arm 50 can increase along a direction towards the support member 101. The inclined surface 711 can be positioned along the third direction C. The mounting member 72 can be fixed to the inclined surface 711. The driving member 74 can be mounted at a side surface of the mounting member 72 and parallel to the mounting member 72. The first transmission member 75 can be a rod, and opposite ends thereof can be mounted at sidewalls of the mounting member 72. The first transmission member 75 can be located along the third direction C.

The intermediate transmission assembly 750 can include a first transmission pulley 751, a second transmission pulley 753, and a transmission belt 755. The first transmission pulley 751 can be sleeved on a driving end of the driving member 74. The second transmission pulley 753 can be sleeved on a first end of the first transmission member 75 adjacent to the driving member 74. The transmission belt 755 can be sleeved on the first transmission pulley 751 and the second transmission pulley 753. The driving member 74 can rotate the first transmission pulley 751, and then the first transmission member 75 can be rotated by the transmission belt 755 and the second transmission pulley 753. The respective structures and coupling relationship of the first transmission member 75, the second transmission member 76, the third transmission member 77 and the protecting plate 78 can be substantially the same as those of first transmission member 35, the second transmission member 36, the third transmission member 37, and the protecting plate 38 of the first arm 30. Thus, an explanation of the first transmission member 75, the second transmission member 76, the third transmission member 77, and the protecting plate 78 is omitted. The first transmission member 75 of the third arm 70 can be located along the third direction C. The protecting cover 79 can be mounted on a distal end of the mounting member 72 and cover the first transmission member 751, the second transmission member 753, and the transmission belt 755.

The second robot arm assembly 103 can also include a first arm 30′, a second arm 50′, and a third arm 70′. The first arm 30′ can be mounted on the support arm 101 and located opposite to the first arm 30. The first arm 30′ can be located parallel to the first arm 30′. Thus, the first arm 30′ can be also arranged along the first direction A. The second arm 50′ can be mounted on the first arm 30′ and located opposite to the second arm 50. The second arm 50′ can be located parallel to the second arm 50. Thus, the second arm 50′ can be also arranged along the second direction B. The first arm 30, the second arm 50, the first arm 30′, and the second arm 50′ can together define a substantially rectangular hollow frame. Thus, a space occupied by the robot 100 in a plane parallel to the first arm 30 and the second arm 50 is small. The third arm 70′ can be mounted on the second arm 50′ and located opposite to the third arm 70. The third arm 70′ can be arranged along a fourth direction C′. The fourth direction C′ and the third direction C can be axisymmetric about the axis perpendicular to the support member 101. A distal end of the third arm 70 adjacent the support member 101 and a distal end of the third arm 70′ adjacent the support member 101 can be close to each other. A structure of the first arm 30′ can be substantially same as the structure of the first arm 30. A structure of the second arm 50′ can be substantially same as the structure of the second arm 50. A structure of the third arm 70′ can be substantially same as the structure of the third arm 70. Coupling relationships of the first arm 30′, the second arm 50′, and the third arm 70′ can be substantially the same as those of the first arm 30, the second arm 50, and the third arm 70. Structures and coupling relationships of the first arm 30′, the second arm 50′, and the third arm 70′ follow the descriptions above.

The first actuating mechanism 90 can be mounted on the third arm 70 and can slide along the third direction C driven by the third arm 70. The first actuating mechanism 90 can include a mounting frame 91, an actuating member 93, and a camera 95. The actuating member 93 and the camera 95 can be mounted on the mounting frame 91. The mounting frame 91 can include a first plate 911 and a second plate 913 fixed to the first plate 911. The first plate 911 can be fixed to the third transmission member 77 of the third arm 70 along the third direction C. Thus, the first plate 911 can be capable of moving along the third direction C when driven by the third transmission member 77. The second plate 913 can be perpendicular to the first plate 911. The actuating member 93 can be perpendicularly mounted on the second plate 913 and move along the third direction C with the mounting frame 91. In the illustrated embodiment, the actuating member 93 can be a probe for detecting the workpiece. In an alternative embodiment, the actuating member 93 can be some other tool, for example the actuating member 93 can be a pneumatic clamp, for assembling a screw to a workpiece. The camera 95 can be fixed to the first plate 911 of the mounting frame 91. The camera can capture an image when the actuating member 93 is detecting the workpiece. A structure of the second actuating mechanism 90′ can be substantially the same as that of the first actuating mechanism 90. The second actuating mechanism 90′ can be mounted on the third arm 70′ and can slide along the fourth direction C′ when driven by the third arm 70. The first actuating mechanism 90 and the second actuating mechanism 90′ can be located above the frame defined by the first arm 30, the second arm 50, the first arm 30′, and the second arm 50′. For example, the first actuating mechanism 90 and the second actuating mechanism 90′ can be located above the first arm 30, the second arm 50, the first arm 30′, and the second arm 50′.

In the illustrated embodiment, the number of the at least one controller 105 is one. The controller 105 can be electrically connected to the driving member 34 of the first arm 30, the driving member 54 of the second arm 50, the driving member 74 of the third arm 70, a driving member of the first arm 30′, a driving member of the second arm 50′, and a driving member of the third arm 70′. The controller 105 can control the above six driving members to work, such that the first robot arm assembly 102 and the second robot arm assembly 103 can simulate two human hands in operating (for example, in detecting or in assembling) controlled by the controller 105. In an alternative embodiment, more than one controller 105 can be implemented, and the more than one controller 105 can cooperatively control the first robot arm assembly 102 and the second robot arm assembly 103.

In assembly, the first arm 30, the second arm 50, the third arm 70, the first arm 30′, the second arm 50′, and the third arm 70′ can be installed. When assembling the first arm 30, the mounting member 32 can be fixed to the connecting member 31. The connection reinforcing member 33 can be fixed within the mounting member 32. The driving member 34 can be mounted on the mounting member 32 and located adjacent to the connection reinforcing member 33. The first transmission member 35 can be received in the mounting member 32 along a longitudinal direction of the mounting member 32. Opposite ends of the first transmission member 35 can be movably inserted through the mounting member 32, and the first transmission member 35 can be coupled to the driving end 343 of the driving member 34. A connecting portion of the driving end 343 and the first transmission member 35 can be received in the connection reinforcing member 33. The second transmission member 36 can be sleeved on the first transmission member 35 and threaded with the first transmission member 35. The third transmission member 36 can be fixed to the second transmission member 36. The protecting plate 38 can pass through the receiving groove 3731 and cover the opening 321 of the mounting member 32. The protecting cover 39 covers the driving member 34. When assembling the second arm 50, the mounting member 52 can be fixed to the second connecting portion 513 of the connecting member 51. Other assembly steps of the second arm 50 can be the same as the assembly steps of the first arm 30. When assembling the third arm 70, the mounting member 72 can be mounted on the inclined surface 711. The driving member 74 can be mounted on a sidewall of the mounting member 72. The first transmission member 75 can be inserted through the mounting member 72. The first transmission pulley 751 and the second transmission pulley 753 can be sleeved on the driving member 74 and the first transmission member 75, respectively. The transmission belt 755 can be wound over the first transmission pulley 751 and the second transmission pulley 753. Other assembly steps of the third arm 30′ can be substantially the same as those for the first arm 30. Assembling the first arm 30′, the second arm 50′, and the third arm 70′ follows the above description.

The assembled first arm 30 and assembled first arm 30′ can be mounted on the support member 101, and the first arm 30 can be parallel to the first arm 30′. The first connecting portion 511 can be perpendicularly fixed to the third transmission member 37 of the first arm 30. The assembled second arm 50 and assembled first arm 50′ can be mounted on the support member 101, and the first arm 30 can be parallel to the first arm 30′. The first connecting portion 511 can be perpendicularly fixed to the third transmission member 37 of the first arm 30, and the second arm 50′ can be perpendicularly fixed to the first arm 30′. The second arm 50 and the second arm 50′ can be located above the first arm 30 and the first arm 30′. The first arm 30 and the second arm 50 can form an L-shape together. The second arm 50 and the second arm 50′ can form an L-shape together. The first arm 30, the second arm 50, the first arm 30′, and the second arm 50′ together can form a hollow frame. The first arm 30, the second arm 50, the first arm 30′ and the second arm 50′ are arranged to be a substantially quadrilateral structure. The connecting member 70 of the third arm 70 can be mounted on the third transmission member 57 of the second arm 50. The third arm 70 can be fixed to the second arm 50′, and the third arm 70 and the third arm 70′ can be axisymmetrically arranged. The first plate 911 of the mounting frame 90 can be fixed to the third transmission member 77 of the third arm 70. The actuating member 93 can be perpendicularly mounted on the second plate 913. The camera 95 can be fixed to the first plate 911 of the mounting frame 91. The first actuating mechanism 90 and the second actuating mechanism 90′ can be respectively mounted on the third arm 70 and the third arm 70′. The controller 105 can be positioned on the support member 101, and can be electrically coupled to the driving member 34 of the first arm 30, the driving member 54 of the second arm 50, the driving member 74 of the third arm 70, the driving member of the first arm 30′, the driving member of the second arm 50′, and the driving member of the third arm 70′.

In operation, a workpiece (not shown) can be positioned in the positioning hole 11, and the actuating member 93 of the first actuating mechanism 90 and an actuating member of the second actuating mechanism 90′ can be located away from the positioning hole 11, to avoid disturbing the positioning of the workpiece. After the workpiece has been positioned, the controller 105 can control the driving body 341 of the first arm 30 to rotate the driving end 343, thus the third transmission member 37 can move along the first transmission member 35 driven by the second transmission member 36. Because the first transmission member 35 is located along the first direction A, the third transmission member 37 moves along the first direction A. The third transmission member 37 can move the second robot arm 50 along the first direction A. Thus, the first arm 30 can drive the second arm 50, the third arm 70, and the first actuating mechanism 90 to move along the first direction A. The controller 105 can control the driving member 53 to enable the third arm 70 and the first actuating mechanism 90 to move along the second direction B. The controller 105 can control the driving member 73 to enable the first actuating mechanism 90 to move along the third direction C. Thus, the actuating member 93 can move towards the workpiece. In the same way, the controller 105 controls the second actuating mechanism 90′ to move along the first direction A, the second direction B, and the fourth direction C′ by the first arm 30′, the second arm 50′, and the third arm 70′, respectively. Therefore, the first actuating member 93 of the first actuating mechanism 90 and the second actuating member of the second actuating mechanism 90′ act together as two human hands to detect the workpiece. The controller 105 controls the first robot arm assembly 102 and the second robot arm assembly 103 to simulate human hands to detect the workpiece. The camera 95 of the first actuating mechanism 90 and a camera of the second actuating mechanism 90′ monitor a detection of the workpiece.

Because the arms of the first robot arm assembly 102 and the second robot arm assembly 103 are arranged on the support member 101 without interference and driving directions of the third arm 70 and third arm 70′ are inclined, the robot 100 size is reduced. The robot 100 uses linear driving structures, without gears or any meshing structure, which also decreases a size and weight of the robot 100. In addition, the third arm 70 and third arm 70′ are inclined. Thus, the first actuating mechanism 90 and the second actuating mechanism 90′ can be inserted into a workpiece with a complex structure, for example, the actuating members can conveniently be inserted into an inclined hole defined on a vertical wall of the workpiece.

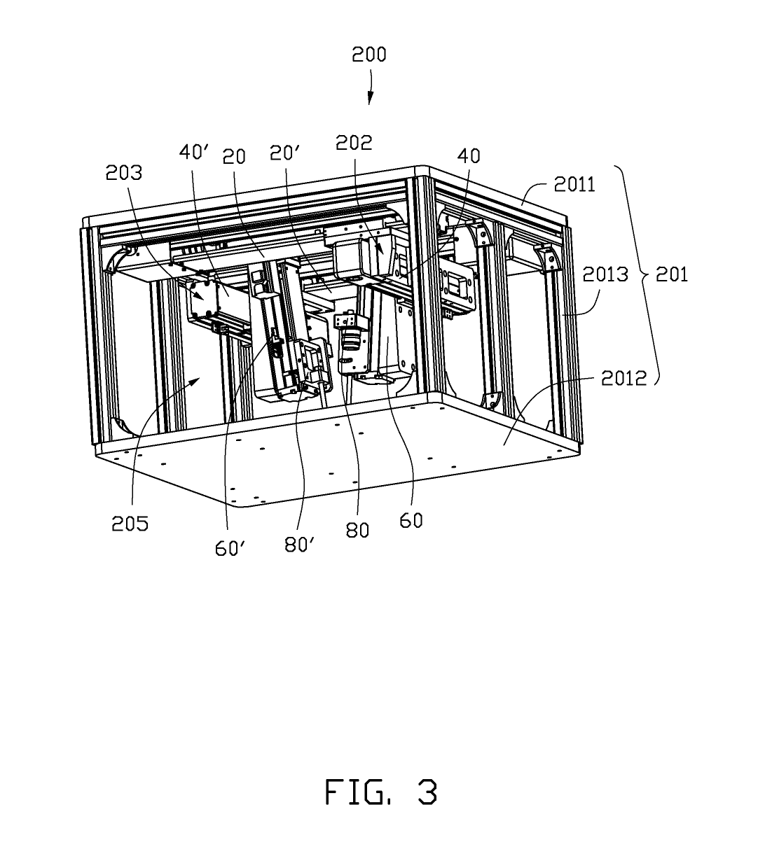

FIG. 3 illustrates a second embodiment of a robot 200, which is similar to the robot 100 of the first embodiment. The robot 200 can include a support frame 201, a first robot arm assembly 202, a second robot arm assembly 203, a first actuating mechanism 80, a second actuating mechanism 80′, and a controller 105. The support frame 201 can include a top plate 2011, a bottom plate 2012, and a plurality of coupling rods 2013. The top plate 2011 and the bottom plate 2012 can be parallel to each other. The coupling rods 2013 can interconnect the top plate 2011 and the bottom plate 2013. The top plate 2011, the bottom plate 2012, and the coupling rods 2013 can together define a receiving chamber 2015. The first robot arm assembly 202, the second robot arm assembly 203, and the controller 105 can be mounted on the top plate 2011 of the support frame 201 and be received in the receiving chamber 2015. Structures and relationships of the first robot arm assembly 202, the second robot arm assembly 203, the first actuating mechanism 80, the second actuating mechanism 80′ and the controller 105 are the same as the structures and relationships of the first robot arm assembly 102, the second robot arm assembly 103, the first actuating mechanism 90, the second actuating mechanism 90′, and the controller 105 of the first embodiment. Explanations of structures and relationships of the first robot arm assembly 202, the second robot arm assembly 203, the first actuating mechanism 80, the second actuating mechanism 80′, and the controller 105 are thus simplified.

The first robot arm assembly 202 can include a first arm 20, a second arm 40, and a third arm 60. The second robot arm assembly 203 can include a first arm 20′, a second arm 40′, and a third arm 60′. The first arm 20 and the second arm 20′ can be mounted on the top plate 2011 and parallel to each other. The second arm 40 can be slidably mounted on the first arm 20 and located at a side of the first arm 20 away from the top plate 2011. The second arm 40′ can be slidably mounted on the first arm 20′ and located at a side of the first arm 20′ away from the top plate 2011. The first arm 20, the second arm 40, the first arm 20′, and the second arm 40′ together define a substantially rectangular frame. The third arm 60 can be slidably mounted on the second arm 40 and inclined relative to an imaginary plane parallel to a driving direction of the first arm 20 and a driving direction of the second arm 40. The third arm 60′ can be slidably mounted on the second arm 40′ and inclined relative to an imaginary plane parallel to a driving direction of the first arm 20′ and a driving direction of the second arm 40′. The driving direction of the first arm 20 can be parallel to the driving direction of the first arm 20′. The driving direction of the second arm 40 can be parallel to the driving direction of the second arm 40′.

A distance between the third arm 60 and the third arm 60′ decreases gradually along a direction towards bottom plate 2012, that is, the distance between the third arm 60 and the third arm 60′ decreases towards the direction of down. The first actuating mechanism 80 can be slidably mounted on the third arm 60. A moving direction of the first actuating mechanism 80 can be inclined relative to an imaginary plane parallel to a moving direction of the second arm 40 and a moving direction of the third arm 60. The second actuating mechanism 80′ can be slidably mounted on the third arm 60′. A moving direction of the second actuating mechanism 80′ can be inclined relative to an imaginary plane parallel to a moving direction of the second arm 40′ and a moving direction of the third arm 60′.

In the illustrated embodiment, the moving direction of the first actuating mechanism 80 and the moving direction of the second actuating mechanism 80′ can be axisymmetric about an axis perpendicular to the bottom plate 2012. Structures and coupling relationships of the first arm 20, the second arm 40, the third arm 60, the first actuating mechanism 80, the first arm 20′, the second arm 40′, the third arm 60′, and the second actuating mechanism 80′ can be substantially the same as those of the first arm 30, the second arm 50, the third arm 70, the first actuating mechanism 90, the first arm 30′, the second arm 50′, the third arm 70′, and the second actuating mechanism 90′. Thus, an explanation of the structures and coupling relationships of the first arm 20, the second arm 40, the third arm 60, the first actuating mechanism 80, the first arm 20′, the second arm 40′, the third arm 60′, the second actuating mechanism 80′ can be the same as the descriptions above.

When in operation, a workpiece can be mounted on the bottom plate 2012 of the support frame 201 and located between the first actuating mechanism 80 and the second actuating mechanism 80′. The controller 105 can control the first arm 20, the second arm 40, and the third arm 60 to drive the first actuating mechanism 80 and control the first arm 20′, the second arm 40′, and the third arm 60′ to drive the second actuating mechanism 80′. Thus, the first actuating mechanism 80 and the second actuating mechanism 80′ can cooperatively detect and/or machine the workpiece. Because arms of the robot 200 are located on the top plate 2011 of the support frame 201, a complex structure on the bottom plate 2012 is avoided and interference with other outer or peripheral devices, such as feeding device or conveyor, for example, is also avoided.

In an alternative embodiment, the first arm 30 of the first robot arm assembly 102 and the first arm 30′ of the second robot arm assembly 103 can be the same arm, thus the second arm 50 and the second arm 50′ can be mounted on the same arm to move along the same straight line. The first arm assembly 102 and the second arm assembly 103 can be located on different planes at different heights, and the first arm assembly 202 and the second arm assembly 203 can be located on different planes at different heights. For example, the first robot arm assembly 202 can be located on the top plate 2011 and the second robot arm assembly 203 can be located on the bottom plate 2011, such that the first actuating mechanism 80 can be located at an end of the third arm 60 adjacent to the bottom plate 2012, and the second actuating mechanism 80′ can be located at an end of the third arm 60′ adjacent to the bottom plate 2012. The first arm 30 and the first arm 30′ can be located on different horizontal planes; the second arm 50 and the second arm 50′ can be located on different horizontal planes. The third arm 70 and the third arm 70′ can be located at different heights. Thus, the first arm 30 and the first arm 30′ can be vertically staggered, the second arm 50 and the second arm 50′ can be vertically staggered, and the third arm 70 and the third arm 70′ can be vertically staggered, such that the first actuating mechanism 80 and the second actuating mechanism 80′ can be vertically staggered.

In an alternative embodiment, the connecting members 31, 51, 71, the connection reinforcing members 33, 53, the first transmission member 35, 55, 57, the second transmission members 36, 56, 76, the third transmission members 37, 57, 77, the first transmission pulley 751, the second transmission pulley 753, and the transmission belt 755 can be omitted, such that the mounting member 53 of the second arm 50 can be directly coupled to the driving member 34, the mounting member 72 of the third arm 70 can be directly coupled to the driving member 54, the first actuating mechanism 90 can be directly coupled to the driving member 74, and the driving members 34, 54, 74 can be motors. The third direction C and the fourth direction C′ can be inclined relative to the first direction A and the second direction B, and the inclined surface 711 and the inclined surface of the third arm 70′ can inclined relative to the first direction A and the second direction B. The first direction A can be non-perpendicular to the second direction B.

In an alternative embodiment, the third direction C and the fourth direction C′ can be inclined at different degrees relative to the first direction. The robot 100 can include more than two robot arm assemblies to according to different requirements.

It is believed that the present embodiments and their advantages will be understood from the foregoing description, and it will be apparent that various changes can be made thereto without departing from the spirit and scope of the embodiments or sacrificing all of its material advantages.

What is claimed is:

1. A robot comprising:
at least two robot arm assemblies, each robot arm assembly comprising a first arm, a second arm intersecting with the first arm, a third arm intersecting with the second arm, the first arm being configured to drive the second arm to move along the first arm, and wherein the second arm being configured to drive the third arm to move long the second arm;
at least two actuating mechanisms coupled to the third arms of the at least two robot arm assemblies, respectively;
each third arm being configured to drive the corresponding one of the at least two actuating mechanisms along the third arm in a moving direction;
each actuating mechanism driven by the third arm being inclined relative to a plane of the third arm moving therein; and
at least one controller electrically coupled to the first arm, the second arm, the third arm, the at least one controller configured to control the first arms, the second arms, the third arms to move the at least two actuating mechanism.

2. The robot of claim 1, wherein the at least two robot arm assemblies comprises two robot arm assemblies;
the first arms of the two robot arm assemblies are located opposite to each other;
the second arms of the two robot arm assemblies are located opposite to each other;
the first arms of the robot arm assemblies and the second arms of the robot arm assemblies are arranged to be a quadrangle.

3. The robot of claim 2, wherein each arm of the first arms, the second arms, and the third arms comprises a mounting member and a driving member mounted on the mounting member and electrically coupled to the at least one controller;
the mounting members of the first arms are located opposite to each other, and the mounting members of the second arms are located opposite to each other and are coupled to the driving members of the first arms, respectively;
the mounting members of the thirds arms are coupled to the driving members of the second arms, respectively;
the at least two actuating mechanisms are coupled to the driving members of the third arms, the at least one controller is configured to control the driving members of the first arms, the second arms, and the third arms to move the at least two actuating mechanisms.

4. The robot of claim 3, wherein each arm of the first arms, the second arms, and the third arms further comprises a first transmission member and a second transmission member threaded with the first transmission member, each first transmission member is received in the corresponding mounting member and coupled to the corresponding driving member;
each second transmission member of the first arms is coupled to the corresponding mounting member of the second arms;
each second transmission member of the second arms is coupled to the corresponding mounting member of the third arms; and
each second transmission member of the third arms is coupled to the corresponding one of the at least two actuating members.

5. The robot of claim 4, wherein each arm of the first arms, the second arms, and the third arms further comprises a connection reinforcing member mounted within the corresponding mounting member, each driving member comprises a driving body and a driving end coupled to the driving body, the driving body is coupled to the corresponding mounting member, each driving end is inserted into the corresponding mounting member and coupled to the corresponding first transmission member, each connection reinforcing member is sleeved on a connecting portion of the corresponding first transmission member and the corresponding driving end.

6. The robot of claim 3, wherein each third arm further comprises a connecting member, each connecting member of the third arms is coupled to the corresponding mounting member of the second arms, each connecting member comprises an inclined surface located at a side away from the corresponding mounting member of the second arms, each mounting member of the third arms is coupled to the corresponding inclined surface.

7. The robot of claim 5, wherein each third arm further comprises a middle transmission assembly, the middle transmission assembly comprises a first transmission pulley, a second transmission pulley, and a transmission belt;
the first transmission pulley is sleeved on a driving end of the driving member of the third arm;
the second transmission pulley is sleeved on the first transmission member of the third arm;
the transmission belt winds on the first transmission pulley and the second transmission pulley.

8. The robot of claim 1, wherein the robot arm further comprises a support frame, the support frame comprises a top plate and a bottom plate opposite to the top plate;
the first arms of the at least two robot arm assemblies are mounted on the top plate;
the at least two robot arm assemblies are located between the top plate and the bottom plate.

9. A robot comprising:
a support frame comprising a top plate, a bottom plate, and a plurality of coupling rods interconnecting the top plate and the bottom plate, the top plate, the bottom plate, and the coupling rods defining a receiving chamber, cooperatively;
two robot arm assemblies received in the receiving chamber, each robot arm assembly comprising a first arm, a second arm intersecting with the first arm, a third arm intersecting with the second arm;
the first arm being configured to drive the second arm to move along the first arm;
the second arm being configured to drive the third arm to move long the second arm; and
two actuating mechanisms received in the receiving chamber and coupled to the third arms of the two robot arm assemblies, respectively;
each third arm being configured to drive the corresponding one of the two actuating mechanisms along the third arm in a moving direction;
each actuating mechanism driven by the third arm being inclined relative to a driving direction of the first arm and a driving direction of the second arm.

10. The robot of claim 9, wherein the first arms of the robot arm assemblies are located opposite to each other;
the second arms of the two robot arm assemblies are located opposite to each other;
the first arms of the two robot arm assemblies and the second arms of the robot arm assemblies are arranged to be a quadrangle.

11. The robot of claim 10, wherein each arm of the first arms, the second arms, and the third arms comprises a mounting member and a driving member mounted on the mounting member;
the mounting members of the first arms are located opposite to each other, and the mounting members of the second arms are located opposite to each other and are coupled to the driving members of the first arms, respectively;
the mounting members of the thirds arms are coupled to the driving members of the second arms, respectively;
the actuating mechanisms are coupled to the driving members of the third arms.

12. The robot of claim 11, wherein each arm of the first arms, the second arms, and the third arms further comprises a first transmission member and a second transmission member threaded with the first transmission member, each first transmission member is received in the corresponding mounting member and coupled to the corresponding driving member;
each second transmission member of the first arms is coupled to the corresponding mounting member of the second arms;
each second transmission member of the second arms is coupled to the corresponding mounting member of the third arms; and
each second transmission member of the third arms is coupled to the corresponding one of the two actuating members.

13. The robot of claim 12, wherein each arm of the first arms, the second arms, and the third arms further comprises a connection reinforcing member mounted within the corresponding mounting member, each driving member comprises a driving body and a driving end coupled to the driving body, the driving body is coupled to the corresponding mounting member, each driving end is inserted into the corresponding mounting member and coupled to the corresponding first transmission member, each connection reinforcing member is sleeved on the corresponding first transmission member and the corresponding driving end.

14. The robot of claim 11, wherein each third arm further comprises a connecting member, each connecting member of the third arms is coupled to the corresponding mounting member of the second arms, each connecting member comprises an inclined surface, each mounting member of the third arms is coupled to the corresponding inclined surface.

15. The robot of claim 13, wherein each third arm further comprises a middle transmission assembly, the middle transmission assembly comprises a first transmission pulley, a second transmission pulley, and a transmission belt;
the first transmission pulley is sleeved on a driving end of the driving member of the third arm;
the second transmission pulley is sleeved on the first transmission member of the third arm;
the transmission belt winds on the first transmission pulley and the second transmission pulley.
